(19) United States
(12) Patent Application Publication
(10) Pub. No.: US 2023/0173885 A1
(43) Pub. Date: Jun. 8, 2023

(54) VEHICULAR THERMAL MANAGEMENT SYSTEM

(71) Applicant: Hanon Systems, Daejeon (KR)

(72) Inventors: Jae Min LEE, Daejeon (KR); Young Man KIM, Daejeon (KR); Young Chul KIM, Daejeon (KR); In Hyeok KIM, Daejeon (KR); Kyeong Cheol LEE, Daejeon (KR)

(21) Appl. No.: 17/921,212

(22) PCT Filed: May 28, 2021
(86) PCT No.: PCT/KR2021/006648

§ 371 Date: Oct. 25, 2022

(30) Foreign Application Priority Data
Jun. 2, 2020 (KR) 10-2020-0066418

(51) Int. Cl. B60H 1/00

(52) U.S. Cl. CPC B60H 1/00914; B60H 1/00278; B60H 1/00385; B60H 1/00485; F25B 2400/19; B60H 2001/00949

(57) ABSTRACT

A vehicular thermal management system includes: a refrigerant circulation line including a compressor, a high-pressure heat exchanger, an outdoor heat exchanger, a plurality of expansion valves and a low-pressure heat exchanger; an air conditioning mode branch line configured to allow a refrigerant passing through the compressor and the high-pressure heat exchanger to circulate in the order of the outdoor heat exchanger and the low-pressure heat exchanger in an air conditioning mode; a heat pump mode branch line configured to allow the refrigerant passing through the compressor and the high-pressure heat exchanger to circulate by bypassing the outdoor heat exchanger and the low-pressure heat exchanger in a heat pump mode; and a refrigerant/oil recovery part configured to, when one of the branch lines is used, recover the refrigerant and oil in the other unused branch line to the compressor.

### TECHNICAL FIELD

The present invention relates to a vehicular thermal management system and, more particularly, to a vehicular thermal management system configured so that the refrigerant and oil on the side of an air conditioning mode branch line can be recovered to a compressor during a heat pump mode, thereby preventing the stagnation of the refrigerant and oil due to the blockage of the air conditioning mode branch line and the resultant shortage in the circulation amount of the refrigerant and oil during the heat pump mode.

### BACKGROUND ART

Examples of an eco-friendly vehicle include an electric vehicle, a hybrid vehicle, and a fuel cell vehicle (hereinafter collectively referred to as “vehicle”).

Such a vehicle is equipped with various thermal management devices. For example, as shown in FIG. 1, the thermal management devices include an air conditioner 10 for cooling and heating a vehicle interior, a water-cooled battery cooling device 20 for cooling a battery B, a water-cooled electric component module cooling device 30 for cooling an electric component module C, and the like.

The air conditioner 10 is of a heat pump type and is provided with a refrigerant circulation line 12. The refrigerant circulation line 12 includes a compressor 14, a high-pressure heat exchanger 15, a first expansion valve 16, an air conditioning mode branch line 17 branched from the outlet side of the first expansion valve 16, a heat pump mode branch line 18, and a three-way flow control valve 19 for introducing the refrigerant from the first expansion valve 16 to one of the air conditioning mode branch line 17 or the heat pump mode branch line 18.

The air conditioning mode branch line 17 includes an outdoor heat exchanger 17a, a vehicle-interior-cooling low-pressure heat exchanger 17b-1, a battery-cooling low-pressure heat exchanger 17b-2 installed in parallel with vehicle-interior-cooling low-pressure heat exchanger 17b-1, and second expansion valves 17c provided on the upstream sides of the low-pressure heat exchangers 17b-1 and 17b-2, respectively.

During the air conditioning mode, the air conditioning mode branch line 17 allows the refrigerant passed through the compressor 14 and the high-pressure heat exchanger 15 to circulate through the outdoor heat exchanger 17a, the second expansion valves 17c, and the low-pressure heat exchangers 17b-1 and 7b-2 in the named order.

Accordingly, the compressor 14, the high-pressure heat exchanger 15, the outdoor heat exchanger 17a, the second expansion valves 17c, and the low-pressure heat exchangers 17b-1 and 17b-2 form an air conditioning circulation loop so as to cool the vehicle interior and the battery B.

The heat pump mode branch line 18 is equipped with an electric component waste heat chiller 18a. During the heat pump mode, the heat pump mode branch line 18 allows the refrigerant passed through the compressor 14, the high-pressure heat exchanger 15 and the first expansion valve 16 to circulate toward the electric component waste heat chiller 18a.

Accordingly, the compressor 14, the high-pressure heat exchanger 15, the first expansion valve 16 and the electric component waste heat chiller 18a form a heat pump circulation loop so as to cool the vehicle interior.

The water-cooled battery cooling device 20 cools the battery B using the cold air generated in the battery-cooling low-pressure heat exchanger 17b-2, and includes a battery side cooling water circulation line 22 for circulating cooling water between the battery-cooling low-pressure heat exchanger 17b-2 and the battery B.

During the air conditioning mode, the battery side cooling water circulation line 22 allows cooling water to circulate between the battery-cooling low-pressure heat exchanger 17b-2 and the battery B, so that the cold air generated in the battery-cooling low-pressure heat exchanger 17b-2 can be transferred to the battery B. Accordingly, the battery B is cooled.

The water-cooled electric component module cooling device 30 cools the electric component module C using the cold air generated by the electric component waste heat chiller 18a of the air conditioner 10, and includes an electric-component-module side cooling water circulation line 32 for allowing cooling water to circulate between the electric component waste heat chiller 18a and the electric component module C.

During the heat pump mode, the electric-component-module side cooling water circulation line 32 allows cooling water to circulate between the electric component waste heat chiller 18a and the electric component module C, so that the cooling water in the electric component waste heat chiller 18a and the cooling water in the electric-component-module side cooling water circulation line 32 can exchange heat with each other. Through this heat exchange action, the cold air generated in the electric component waste heat chiller 18a can be transferred to the electrical component module C. Accordingly, the electric component module C is cooled.

In the heat exchange process between the cooling water in the electric component waste heat chiller 18a and the cooling water in the electric-component-module side cooling water circulation line 32, the waste heat of the electric component module C absorbed to the cooling water is transferred to the refrigerant in the electric component waste heat chiller 18a. In this process, the waste heat of the electric component module C is recovered to the refrigerant circulation line 12, thereby enhancing the heat pump mode efficiency of the air conditioner 10.

However, since the conventional air conditioner 10 has a structure in which the air conditioning mode branch line 17 used in the air conditioning mode and the heat pump mode branch line 18 used in the heat pump mode are separated from each other, one of the air conditioning mode branch line 17 or the heat pump mode branch line 18 is blocked depending on the air conditioning mode or the heat pump mode. Thus, the refrigerant in the blocked branch line 17 or 18 is not circulated and is stagnant.

In particular, as shown in FIG. 1, the air conditioning mode branch line 17 has a relatively long length as compared with the heat pump mode branch line 18. Therefore, when the air conditioning mode branch line 17 is blocked in the heat pump mode, the refrigerant on the air conditioning mode branch line 17 is trapped in the air conditioning mode branch line 17 and cannot circulate to the compressor 14.

Thus, the amount of the refrigerant circulated in the refrigerant circulation line 12 in the heat pump mode is remarkably reduced. This reduces the efficiency of the heat pump mode and significantly reduces the heating performance for the vehicle interior.

In addition, the refrigerant contains oil for lubricating various sliding parts of the air conditioner 10. The oil is also trapped in the air conditioning mode branch line 17 during the heat pump mode.

Therefore, the amount of the oil circulated in the refrigerant circulation line 12 becomes insufficient. As a result, the lubricity of the sliding parts such as the compressor 14 and the like is lowered, and the lifespan of the sliding parts is shortened.

### SUMMARY

In view of the problems inherent in the related art, it is an object of the present invention to provide a vehicular thermal management system capable of allowing the refrigerant and oil on the side of an air conditioning mode branch line to be recovered to a compressor during a heat pump mode.

Another object of the present invention is to provide a vehicular thermal management system capable of preventing the stagnation of the refrigerant and oil due to the blockage of an air conditioning mode branch line and the resultant shortage in the circulation amount of the refrigerant and oil during the heat pump mode.

A further object of the present disclosure is to provide a vehicular thermal management system capable of allowing a sufficient amount of refrigerant and oil to circulate through a refrigerant circulation line, improving the efficiency of the heat pump mode, and prolonging the lifespan of respective sliding parts of a refrigerant circulation line.

In order to achieve these objects, there is provided a vehicular thermal management system, including: a refrigerant circulation line including a compressor, a high-pressure heat exchanger, an outdoor heat exchanger, a plurality of expansion valves and a low-pressure heat exchanger; an air conditioning mode branch line configured to allow a refrigerant passing through the compressor and the high-pressure heat exchanger to circulate in the order of the outdoor heat exchanger and the low-pressure heat exchanger in an air conditioning mode; a heat pump mode branch line configured to allow the refrigerant passing through the compressor and the high-pressure heat exchanger to circulate by bypassing the outdoor heat exchanger and the low-pressure heat exchanger in a heat pump mode; and a refrigerant/oil recovery part configured to, when one of the air conditioning mode branch line or the heat pump mode branch line is used according to an air conditioning mode, recover the refrigerant and oil in the other unused branch line to the compressor.

In the system, the low-pressure heat exchanger includes a vehicle-interior-cooling low-pressure heat exchanger and a battery-cooling low-pressure heat exchanger, the expansion valve on the upstream side of the battery-cooling low-pressure heat exchanger is an electromagnetic variable expansion valve whose opening degree is variably controlled, and the refrigerant/oil recovery part includes a control part configured to, in the heat pump mode, open the expansion valve on the upstream side of the battery-cooling low-pressure heat exchanger so that one end portion of the air conditioning mode branch line corresponding to a suction port of the compressor is opened to allow the refrigerant and oil in the air conditioning mode branch line to be recovered to the compressor.

In the system, the control part is configured to, in the heat pump mode, completely open the expansion valve on the upstream side of the battery-cooling low-pressure heat exchanger to increase a recovery rate of the refrigerant and oil in the air conditioning mode branch line recovered to the compressor.

According to the vehicular thermal management system of the present invention, when entering the heat pump mode, the second expansion valve on the upstream side of the battery-cooling low-pressure heat exchanger is completely opened. Accordingly, when entering the heat pump mode, it is possible to open the air conditioning mode branch line corresponding to the inlet side of the compressor.

Since the air conditioning mode branch line corresponding to the inlet side of the compressor can be opened when entering the heat pump mode, the refrigerant and oil present in the air conditioning mode branch line can be recovered to the compressor when entering the heat pump mode.

Since the refrigerant and oil present in the air conditioning mode branch line can be recovered to the compressor when entering the heat pump mode, it is possible to prevent the stagnation of the refrigerant and oil due to the blockage of an air conditioning mode branch line and the resultant shortage in the circulation amount of the refrigerant and oil during the heat pump mode.

Since the shortage in the circulation amount of the refrigerant and oil can be prevented during the heat pump mode, it is possible to allow a sufficient amount of refrigerant and oil to circulate through the refrigerant circulation line, improve the efficiency of the heat pump mode, and prolong the lifespan of the respective sliding parts of the refrigerant circulation line by supplying a sufficient amount of oil to the respective sliding parts of the refrigerant circulation line.

### BRIEF DESCRIPTION OF THE DRAWINGS

FIG. 1 is a view showing a conventional vehicular thermal management system.

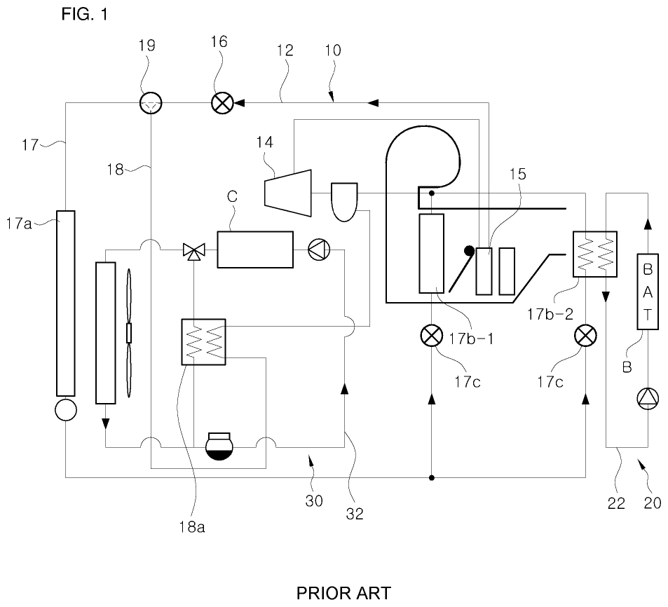

FIG. 2 is a view showing a vehicular thermal management system according to the present invention.

FIGS. 3A and 3B are sectional views showing the details of a second expansion valve on the upstream side of a battery-cooling low-pressure heat exchanger of the vehicular thermal management system according to the present invention.

FIG. 4 is a view showing an operation example of the vehicular thermal management system according to the present invention, and is a diagram showing a refrigerant flow in an air conditioning mode.

FIG. 5 is a view showing an operation example of the vehicular thermal management system according to the present invention, and is a diagram showing a refrigerant flow in a heat pump mode.

### DETAILED DESCRIPTION

Preferred embodiments of a vehicular thermal management system according to the present invention will now be described in detail with reference to the accompanying drawings.

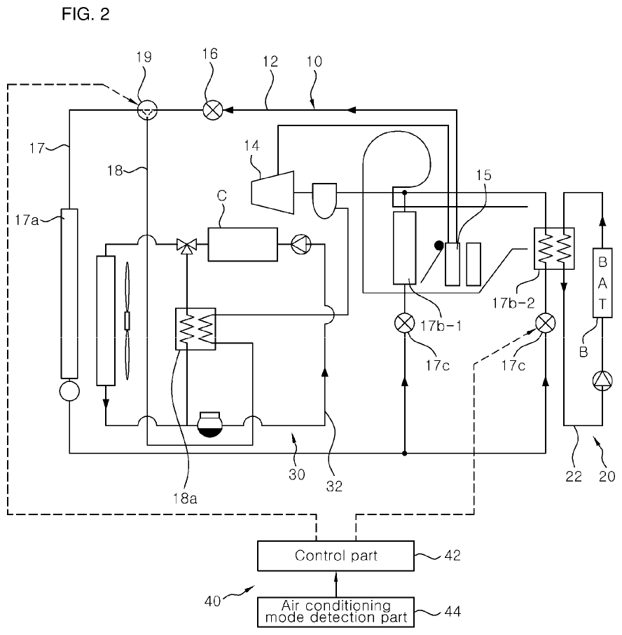

Prior to describing the features of the vehicular thermal management system according to the present invention, the general configurations of the vehicular thermal management system will be briefly described with reference to FIGS. 2 to 5.

As shown in FIG. 2, the vehicular thermal management system includes an air conditioner 10 for cooling and heating a vehicle interior, a water-cooled battery cooling device 20 for cooling a battery B, and a water-cooled electric component module cooling device 30 for cooling an electric component module C.

The air conditioner 10 is of a heat pump type and is provided with a refrigerant circulation line 12. The refrigerant circulation line 12 includes a compressor 14, a high-pressure heat exchanger 15, a first expansion valve 16, an air conditioning mode branch line 17 branched from the outlet side of the first expansion valve 16, a heat pump mode branch line 18, and a three-way flow control valve 19 for introducing the refrigerant from the first expansion valve 16 to one of the air conditioning mode branch line 17 or the heat pump mode branch line 18.

The air conditioning mode branch line 17 includes an outdoor heat exchanger 17a, a vehicle-interior-cooling low-pressure heat exchanger 17b-1, a battery-cooling low-pressure heat exchanger 17b-2 installed in parallel with vehicle-interior-cooling low-pressure heat exchanger 17b-1, and second expansion valves 17c provided on the upstream sides of the low-pressure heat exchangers 17b-1 and 17b-2, respectively.

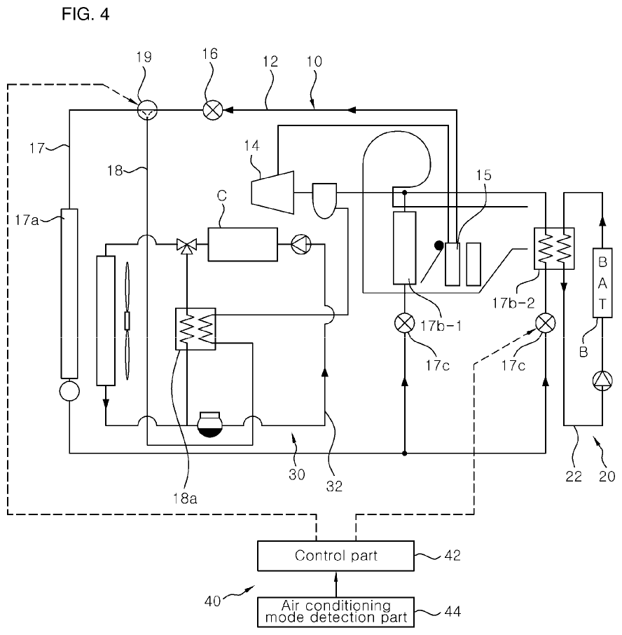

As shown in FIG. 4, during the air conditioning mode, the air conditioning mode branch line 17 allows the refrigerant passed through the compressor 14 and the high-pressure heat exchanger 15 to circulate through the outdoor heat exchanger 17a, the second expansion valves 17c, and the low-pressure heat exchangers 17b-1 and 17b-2 in the named order.

Accordingly, the compressor 14, the high-pressure heat exchanger 15, the outdoor heat exchanger 17a, the second expansion valves 17c, and the low-pressure heat exchangers 17b-1 and 17b-2 form an air conditioning circulation loop so as to cool the vehicle interior and the battery B.

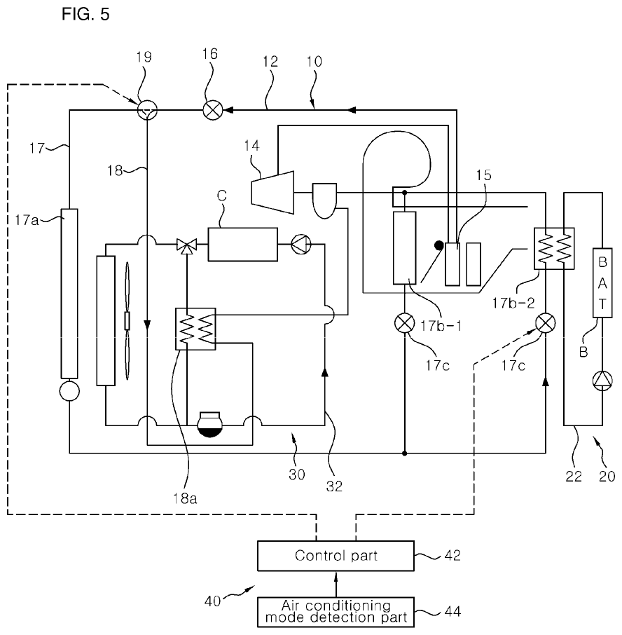

The heat pump mode branch line 18 is equipped with an electric component waste heat chiller 18a. As shown in FIG. 5, during the heat pump mode, the heat pump mode branch line 18 allows the refrigerant passed through the compressor 14, the high-pressure heat exchanger 15 and the first expansion valve 16 to circulate toward the electric component waste heat chiller 18a.

Therefore, the refrigerant passed through the compressor 1 and the high-pressure heat exchanger 15 can circulate toward the electric component waste heat chiller 18a by bypassing the outdoor heat exchanger 17a and the low-pressure heat exchangers 17b-1 and 17b-2.

Accordingly, the compressor 14, the high-pressure heat exchanger 15, the first expansion valve 16 and the electric component waste heat chiller 18a form a heat pump circulation loop so as to cool the vehicle interior.

In this regard, the second expansion valve 17c on the upstream side of the vehicle-interior-cooling low-pressure heat exchanger 17b-1 is configured as a thermosensitive type valve (TXV), and the second expansion valve 17c on the upstream side of the battery-cooling low-pressure heat exchanger 17b-2 and the first expansion valve 16 are configured as electromagnetic type valves (EXV).

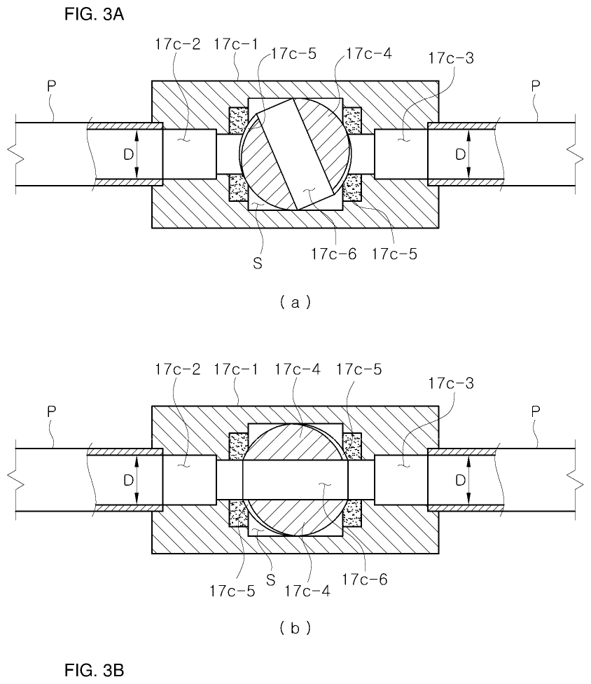

In particular, as shown in FIGS. 3A and 3B, the second expansion valve 17c on the upstream side of the battery-cooling low-pressure heat exchanger 17b-2 includes, as a ball valve structure, a valve body 17c-1 having a refrigerant inlet 17c-2 and a refrigerant outlet 17c-3, and a spherical valve body 17c-4 provided between the refrigerant inlet 17c-2 and the refrigerant outlet 17c-3.

The valve body 17c-4 is rotatably installed in the spherical valve chamber S between the refrigerant inlet 17c-2 and the refrigerant outlet 17c-3, and includes expansion flow paths 17c-5 corresponding to the refrigerant inlet 17c-2 and the refrigerant outlet 17c-3, respectively, and a fully opening flow path 17c-6 for bringing the refrigerant inlet 17c-2 and the refrigerant outlet 17c-3 into direct communication with each other.

During the air conditioning mode, as shown in FIG. 3A, the expansion paths 17c-5 variably adjust the opening degree of a flow path between the refrigerant inlet 17c-2 and the refrigerant outlet 17c-3 according to the rotational position of the valve body 17c-4. As a result, the expansion flow paths 17c-5 adjust the pressure reduction and expansion amount of the refrigerant during the air conditioning mode.

During the heat pump mode, as shown in FIG. 3B, the fully opening flow path 17c-6 fully opens the refrigerant inlet 17c-2 and the refrigerant outlet 17c-3 depending on the rotational position of the valve body 17c-4. Therefore, during the heat pump mode, the fully opening flow path 17c-6 passes the refrigerant transferred through the refrigerant pipe P as it is without pressure reduction and expansion.

The fully opening flow path 17c-6 is configured to have a diameter of 80% or more of the diameter D of the refrigerant pipe P on the side of the refrigerant inlet 17c-2 and the refrigerant outlet 17c-3. Therefore, the fully opening flow path 17c-6 can pass the refrigerant transferred through the refrigerant pipe P as it is without pressure reduction and expansion.

Referring again to FIG. 2, the water-cooled battery cooling device 20 includes a battery side cooling water circulation line 22 for circulating cooling water between the battery-cooling low-pressure heat exchanger 17b-2 and the battery B.

During the air conditioning mode, as shown in FIG. 4, the battery side cooling water circulation line 22 allows cooling water to circulate between the battery-cooling low-pressure heat exchanger 17b-2 and the battery B, so that the cold air generated in the battery-cooling low-pressure heat exchanger 17b-2 can be transferred to the battery B. Accordingly, the battery B is cooled.

The water-cooled electric component module cooling device 30 includes an electric-component-module side cooling water circulation line 32 for allowing cooling water to circulate between the electric component waste heat chiller 18a and the electric component module C.

During the heat pump mode, the electric-component-module side cooling water circulation line 32 allows cooling water to circulate between the electric component waste heat chiller 18a and the electric component module C, so that the cooling water in the electric component waste heat chiller 18a and the cooling water in the electric-component-module side cooling water circulation line 32 can exchange heat with each other. Through this heat exchange action, the cold air generated in the electric component waste heat chiller 18a can be transferred to the electrical component module C. Accordingly, the electric component module C is cooled.

In the heat exchange process between the cooling water in the electric component waste heat chiller 18a and the cooling water in the electric-component-module side cooling water circulation line 32, the waste heat of the electric component module C absorbed to the cooling water is transferred to the refrigerant in the electric component waste heat chiller 18a. In this process, the waste heat of the electric component module C is recovered to the refrigerant circulation line 12.

Next, features of the vehicular thermal management system according to the present invention will be described in detail with reference to FIGS. 2 to 5.

Referring first to FIG. 2, the vehicular thermal management system of the present invention further includes a refrigerant/oil recovery part 40 configured to, when one of the air conditioning mode branch line 17 or the heat pump mode branch line 18 is used according to the air conditioning mode, recover the refrigerant and the oil in the other unused branch line to the compressor 14.

The refrigerant/oil recovery part 40 includes a control part 42. The control part 42 is equipped with a microprocessor. When the air conditioning mode detection part 44 detects that the current air conditioning mode is changed from the air conditioning mode to the heat pump mode, the control part 42 controls the variable second expansion valve 17c on the upstream side of the battery-cooling low-pressure heat exchanger 17b-2.

In particular, the second expansion valve 17c is controlled so that it can be opened. Preferably, as shown in FIG. 3B, the second expansion valve 17c is controlled so that the fully opening flow path 17c-6 of the second expansion valve 17c can bring the refrigerant inlet 17c-2 and the refrigerant outlet 17c-3 into complete communication with each other.

Accordingly, the internal flow path of the second expansion valve 17c can be opened by 80% or more of the diameter D of the refrigerant pipe P. Thus, the refrigerant can pass through the refrigerant pipe P as it is without pressure reduction or expansion.

As a result, when entering the heat pump mode, as shown in FIG. 5, the air conditioning mode branch line 17 can be opened. In particular, among the portions of the air conditioning mode branch line 17, one side portion of the air conditioning mode branch line 17 corresponding to the suction port side of the compressor 14 can be opened.

Accordingly, during the heat pump mode, the refrigerant and oil present in the air conditioning mode branch line 17 can be recovered to the compressor 14.

In particular, during the heat pump mode, a negative pressure is formed on the suction port side of the compressor 14. Due to this negative pressure, the refrigerant and oil in the air conditioning mode branch line 17 are sucked into the suction port side of the compressor 14. By virtue of this suction action, the refrigerant and oil in the air conditioning mode branch line 17 are efficiently recovered to the compressor 14.

As a result, unlike the prior art, it is possible to prevent stagnation of the refrigerant and oil and the resultant insufficient circulation of the refrigerant and oil due to the blockage of the air conditioning mode branch line 17.

Accordingly, a sufficient amount of refrigerant and oil can be circulated in the refrigerant circulation line 12. Therefore, it is possible to improve the efficiency of the heat pump mode to improve the heating performance of the vehicle interior, and it is possible to supply a sufficient amount of oil to each sliding part of the refrigerant circulation line 12 to prolong the lifespan of each sliding part.

Meanwhile, in the heat pump mode, the control part 42 controls the three-way flow control valve 19 to completely cut off the refrigerant introduced into the air conditioning mode branch line 17 from the discharge port side of the compressor 14.

This is to completely prevent the introduction of the refrigerant into the air conditioning mode branch line 17, thereby minimizing the amount of refrigerant and oil stagnant in the air conditioning mode branch line 17.

According to the vehicular thermal management system of the present invention having such a structure, when entering the heat pump mode, the second expansion valve 17c on the upstream side of the battery-cooling low-pressure heat exchanger 17b-2 is completely opened. Therefore, when entering the heat pump mode, the air conditioning mode branch line 17 corresponding to the suction port side of the compressor 14 can be opened.

In addition, since the air conditioning mode branch line 17 corresponding to the suction port side of the compressor 14 can be opened when entering the heat pump mode, the refrigerant and oil present in the air conditioning mode branch line 17 can be recovered to the compressor 14 when entering the heat pump mode.

In addition, since the refrigerant and oil of the air conditioning mode branch line 17 can be recovered to the compressor 14 in the heat pump mode, it is possible to prevent stagnation of the refrigerant and oil and the resultant insufficient circulation of the refrigerant and oil due to the blockage of the air conditioning mode branch line 17 during the heat pump mode.

In addition, since it is possible to prevent the insufficient circulation of the refrigerant and oil during the heat pump mode, a sufficient amount of refrigerant and oil can be circulated in the refrigerant circulation line 12, thereby improving the efficiency of the heat pump mode and supplying a sufficient amount of oil to each sliding part of the refrigerant circulation line 12 to prolong the lifespan of each sliding part.

While the preferred embodiments of the present invention have been described above, the present invention is not limited to the above-described embodiments. Various modifications and changes may be made without departing from the scope and spirit of the present invention defined in the claims.

1. A vehicular thermal management system, comprising:
a refrigerant circulation line including a compressor, a high-pressure heat exchanger, an outdoor heat exchanger, a plurality of expansion valves and a low-pressure heat exchanger;
an air conditioning mode branch line configured to allow a refrigerant passing through the compressor and the high-pressure heat exchanger to circulate in the order of the outdoor heat exchanger and the low-pressure heat exchanger in an air conditioning mode;
a heat pump mode branch line configured to allow the refrigerant passing through the compressor and the high-pressure heat exchanger to circulate by bypassing the outdoor heat exchanger and the low-pressure heat exchanger in a heat pump mode; and
a refrigerant/oil recovery part configured to, when one of the air conditioning mode branch line or the heat pump mode branch line is used according to an air conditioning mode, recover the refrigerant and oil in the other unused branch line to the compressor.

2. The system of claim 1, wherein the refrigerant/oil recovery part is configured to, when the refrigerant is circulated through the heat pump mode branch line upon entry into the heat pump mode, recover the refrigerant and oil in the air conditioning mode branch line to the compressor.

3. The system of claim 2, wherein the low-pressure heat exchanger includes a vehicle-interior-cooling low-pressure heat exchanger and a battery-cooling low-pressure heat exchanger,
an expansion valve on the upstream side of the battery-cooling low-pressure heat exchanger is an electromagnetic variable expansion valve whose opening degree is variably controlled, and
the refrigerant/oil recovery part includes a control part configured to, in the heat pump mode, open the expansion valve on the upstream side of the battery-cooling low-pressure heat exchanger so that one end portion of the air conditioning mode branch line corresponding to a suction port of the compressor is opened to allow the refrigerant and oil in the air conditioning mode branch line to be recovered to the compressor.

4. The system of claim 3, wherein the control part is configured to, in the heat pump mode, completely open the expansion valve on the upstream side of the battery-cooling low-pressure heat exchanger to increase a recovery rate of the refrigerant and oil in the air conditioning mode branch line recovered to the compressor.

5. The system of claim 4, wherein the control part is configured to, in the heat pump mode, completely open the expansion valve on the upstream side of the battery-cooling low-pressure heat exchanger so that the opening degree of an internal flow path becomes 80% or more of the diameter of a refrigerant pipe.

6. The system of claim 5, wherein the expansion valve on the upstream side of the battery-cooling low-pressure heat exchanger includes an expansion flow path configured to variably adjust an opening degree between a refrigerant inlet and a refrigerant outlet to variably adjust an amount of pressure reduction and expansion of the refrigerant, and a fully opening flow path configured to pass the refrigerant between the refrigerant inlet and the refrigerant outlet without pressure reduction and expansion.

7. The system of claim 6, wherein the expansion valve on the upstream side of the battery-cooling low-pressure heat exchanger is configured to control the refrigerant with the expansion flow path in the air conditioning mode and control the refrigerant with the fully opening flow path in the heat pump mode.

8. The system of claim 7, wherein the control part is configured to, in the heat pump mode, completely open the expansion valve on the upstream side of the battery-cooling low-pressure heat exchanger through the use of the fully opening flow path.

9. The system of claim 8, wherein the expansion valve on the upstream side of the battery-cooling low-pressure heat exchanger includes a spherical valve body rotatably installed between the refrigerant inlet and the refrigerant outlet, and provided with the expansion flow path and the fully opening flow path,
the expansion flow path is formed on both sides of the valve body to correspond to the refrigerant inlet and the refrigerant outlet and configured to, in the air conditioning mode, adjust the amount of pressure reduction and expansion of the refrigerant by variably adjusting the opening degree between the refrigerant inlet and the refrigerant outlet according to the rotational position of the valve body, and
the fully opening flow path is formed in the valve body to bring the refrigerant inlet and the refrigerant outlet into direct communication with each other, and configured to, in the heat pump mode, fully open the refrigerant inlet and the refrigerant outlet according to the rotational position of the valve body to allow the refrigerant to pass through without pressure reduction or expansion.

10. The system of claim 9, wherein the fully opening flow path of the expansion valve on the upstream side of the battery-cooling low-pressure heat exchanger has a diameter of 80% or more of the diameter of refrigerant pipes on the side of the refrigerant inlet and the refrigerant outlet.

11. The system of claim 1, further comprising:
a three-way flow control valve configured to introduce the refrigerant from the compressor to either one of the air conditioning mode branch line or the heat pump mode branch line according to the air conditioning mode,
wherein the control part is configured to control the three-way flow control valve in the heat pump mode so as to completely cut off a refrigerant flow from the compressor to the air conditioning mode branch line.
